(19) United States
(12) Patent Application Publication
(10) Pub. No.: US 2006/0054012 A1
(43) Pub. Date: Mar. 16, 2006

(54) Hand power tool with percussion bolt sealing

(76) Inventors: Otto Baumann, Leinfelden-Echterdingen (DE); Rolf Mueller, Leinfelden-Echterdingen (DE); Dietmar Saur, Gomaringen (DE); Helmut Heinzelmann, Stuttgart (DE)

Correspondence Address: STRIKER, STRIKER & STENBY, 103 EAST NECK ROAD, HUNTINGTON, NY, 11743, US

(21) Appl. No.: 11/210,915

(22) Filed: Aug. 24, 2005

(30) Foreign Application Priority Data
Sep. 10, 2004 (DE) 10 2004 043831.5

(51) Int. Cl. B64D 1/04

(52) U.S. Cl. 89/1.14

(57) ABSTRACT

A hand power tool has a percussion bolt, a hammer barrel receiving the percussion bolt, a sealing element effecting sealing between the percussion bolt and the hammer barrel, a restraining element that retains the sealing element at a predetermined point along the hammer barrel, and a counterpart element fixing the restraining element in a longitudinal direction of the hammer barrel, wherein the restraining element is located on an outer face, toward the hammer barrel, of the sealing element.

### BACKGROUND OF THE INVENTION

The present invention relates to a hand power tool with a percussion bolt sealing.

More particularly, the invention relates to a hand power tool, in particular a drill hammer and/or percussion hammer, having a hammer barrel receiving a percussion bolt, having a sealing element effecting sealing between the percussion bolt and the hammer barrel, having a restraining element that retains the sealing element at a predetermined point along the hammer barrel, and having a counterpart element fixing the restraining element in the longitudinal direction of the hammer barrel.

Hand power tools of this type are known. They are understood to include all handheld machines, tools, and work equipment that have a mode of operation in which force pulses in the form of impacts, originating at a beater of the hand power tool, are transmitted to a tool insert of the hand power tool—typically by means of a percussion bolt—in order thereby to cause force pulses to act in an operating region to be machined using the hand power tool, and hence especially drill hammers and/or percussion hammers. The percussion bolt of the hand power tool that serves to transmit impacts must be sealed off from the hammer barrel that receives the percussion bolt, to prevent lubricant from escaping from the hand power tool. In this respect, it is for instance known to provide a narrow gap seal between the percussion bolt and the hammer barrel receptacle, to place a sealing element (such as an O-ring) on the percussion bolt, or to introduce a sealing element into the hammer barrel receptacle. In this last version, the sealing element, typically molded from an elastomer material, is press-fitted into the hammer barrel receptacle. The flexible sealing lips of the sealing element protect the tool against the entry of soil, such as abraded metal and rock dust, and against the escape of lubricant.

The demands made in terms of building in the sealing element in oil-lubricated drill hammers and/or percussion hammers are especially stringent. Particularly the press fit of the sealing element to the hammer barrel receptacle is significant, because if the press fit is inadequate, the sealing element can shift in the hammer barrel receptacle, because of vibration and temperature fluctuations. To limit the axial motion of the sealing element, snap rings are for instance used as restraining elements; the snap rings are secured against axial shifting in a counterpart element embodied as a groove. A disadvantage then, however, is that in this embodiment the structural length of the hand power tool is increased, and both the production costs and the effort and expense of assembly and disassembly rise. It is also known to use sealing elements with metal press-fit connections, but these are expensive.

### SUMMARY OF THE INVENTION

Accordingly, it is an object of the present invention to provide a hand power tool with a percussion bolt sealing, which is a further improvement of the existing hand power tools of this type.

According to the invention, it is proposed that the restraining element be located on the outer face, toward the hammer barrel, of the sealing element. This offers one possible way of economically and securely connecting the sealing element to the hammer barrel receptacle, with the shortest possible structural length.

The restraining element enters into a force- and form-locking connection with the counterpart element. The resultant built-in length of the entire sealing apparatus is especially short, since the restraining element is now located in the region—viewed in the longitudinal direction of the hammer barrel—of the length of the sealing element. The press fit of the sealing element and the hammer barrel receptacle can be manufactured inexpensively, and in particular the manufacture of the hammer barrel receptacle becomes more economical, since no postmachining in the hardened state is required. Because of the simplified construction, easy assembly and disassembly of the sealing element is also obtained. The principle of the arrangement according to the invention will be described in further detail later in this specification, in terms of exemplary embodiments.

Advantageously, the counterpart element has at least one partial circular-annular contour and preferably is embodied as a full circular-annular contour. This kind of embodiment is favorable to produce and enables a uniformly distributed absorption of the forces that act on the restraining element and the counterpart element.

In an advantageous embodiment of the invention, the counterpart element is formed of a plurality of counterpart element regions located in the longitudinal direction of the hammer barrel. In this embodiment, the restraining element is not supported on only one counterpart element but rather on a plurality of counterpart element regions, which are located one after the other—as viewed in the longitudinal direction of the hammer barrel. In this way, the fixation of the restraining element can be improved. Such a counterpart element can be realized in particular in the form of an arrangement of a plurality of grooves parallel to one another and spaced apart from one another.

It is advantageous if the counterpart element is embodied as at least one indentation, in particular a plunge cut. In this way, the counterpart element can be manufactured especially simply.

In an advantageous refinement of the invention, the flank angle formed between one flank of the counterpart element, which flank, by means of bearing contact, effects the fixation of the restraining element, and the length of the hammer barrel is an obtuse angle, preferably a right angle. A flank of the counterpart element that is formed in this way can be embodied especially simply.

Advantageously, the restraining element is embodied integrally with the sealing element. Such an embodiment is distinguished by low production costs. Moreover, it is easily attained that the restraining element is fixedly positioned relative to the sealing element.

Advantageously, the restraining element is embodied as a bead pointing radially outward.

It is also advantageous if the restraining element is embodied in the form of a barb.

In a preferred embodiment, the outer face, toward the hammer barrel, of the sealing element or of the restraining element, or of the unit made up of the sealing element and the restraining element, is fluted. It is especially preferred that the outer radius of the annular intermediate ribs, located between two flutes, is greater than the inner radius of the hammer barrel, at the point where the sealing element is positioned in the installed state. Each of the intermediate ribs that does not engage the inside of the counterpart element but instead rests on the wall of the hammer barrel becomes compressed, while each of the intermediate ribs that is positioned diametrically opposite the counterpart element can expand into the counterpart element, and thus effects the positioning of the restraining element and hence also of the sealing element. If the counterpart element is formed of a plurality of counterpart element regions, then the flutes can be embodied such that each individual intermediate rib is associated with precisely one counterpart element region.

Advantageously, the fluting is adapted to the contour of the counterpart element. Thus the seat of the sealing element and of the restraining element can be improved still further.

It is advantageous if the counterpart element is located at the front or in the middle in a receptacle of the hammer barrel. This is in terms of the region along the length of the hammer barrel, across which the sealing element extends. The phrase “at the front” should be understood to mean in the direction of the working region of the hand power tool.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a hand power tool;

FIG. 2 is an enlarged detail of a first exemplary embodiment;

FIG. 3 is an enlarged detail of a second exemplary embodiment;

FIG. 4 shows an embodiment of the counterpart element at the front in the hammer barrel receptacle; and

FIG. 5 shows an embodiment of the counterpart element in the middle of the hammer barrel receptacle.

### DESCRIPTION OF THE PREFERRED EMBODIMENTS

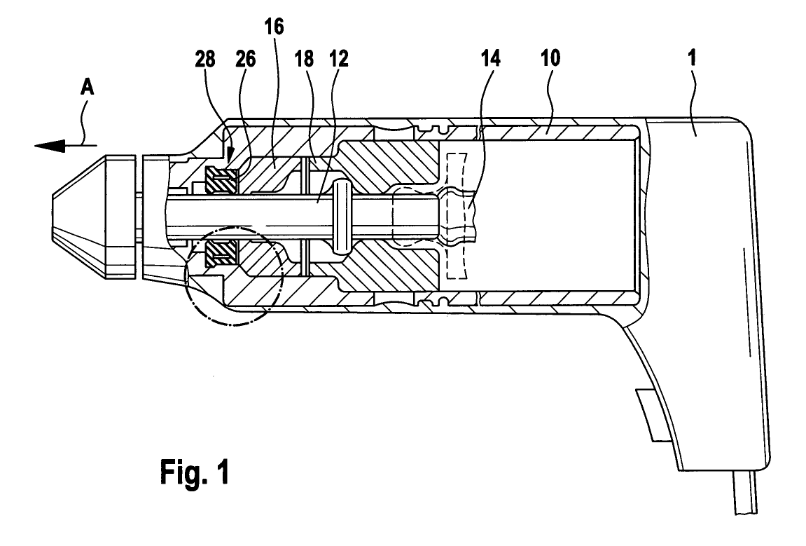

FIG. 1 shows a hand power tool 1—shown symbolically—in this case in the version as a percussion hammer. A percussion bolt 12 that is axially displaceable in the longitudinal direction of the hammer barrel 10 is guided in the hammer barrel 10 and can be acted upon by a force pulse by a beater 14. The axial motion of the percussion bolt 12 is limited, in the direction of the operating region A of the hand power tool 1, by the stop ring 16 and in the direction of a drive unit—not shown—of the hand power tool 1 by the guide bush 18. The sealing element 26 seals off the percussion bolt 12 from the hammer barrel 10 in the region of the hammer barrel receptacle 28. The precise construction will now be described in conjunction with an enlarged detail.

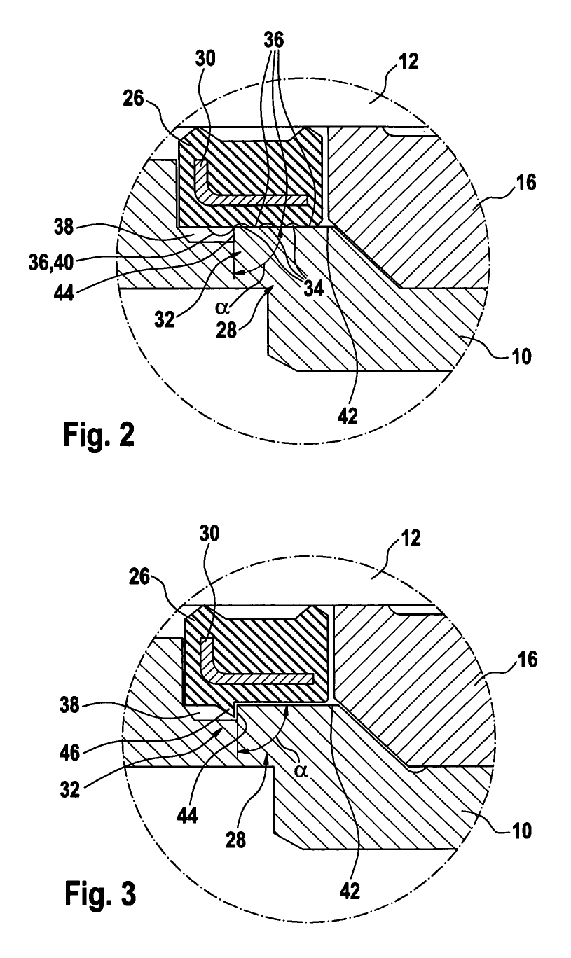

FIG. 2 shows an enlarged detail of the portion shown in FIG. 1. Here again, the percussion bolt 12, the stop ring 16, the hammer barrel 10, the hammer barrel receptacle 28, and the sealing element 26 can be seen. The sealing element 26 has an insert 30, for stabilizing it. The restraining element 32 is located in one piece on the outer face, toward the hammer barrel receptacle 28, of the sealing element 26. This restraining element has a plurality of flutes 34 and a plurality of intermediate ribs 36. A plunge cut in the hammer barrel receptacle 28 forms a counterpart element 38, into which the first intermediate rib 40 has expanded radially. The intermediate ribs 36 that do not engage the inside of the counterpart element 38 cannot expand like the first intermediate rib 40, and they do not rest in compressed form against the wall 42 of the hammer barrel receptacle 28.

The first intermediate rib 40 rests on part of the flank 44, which forms a flank angle α, in this case a right angle, relative to the length of the hammer barrel 10. The sealing element 26 is press-fitted into the hammer barrel receptacle 28 until it comes to a stop. In the terminal position shown, the first intermediate rib 40 has expanded radially, as described above, into the free space of the counterpart element 38. The right-angled flank 44 firmly holds the sealing element 26 securely in the hammer-percussion mode. The flutes 34 (fluting) can be embodied arbitrarily, or they may be adapted to the contour of the counterpart element 38, embodied as a plunge cut. In the exemplary embodiment shown, the counterpart element 38 is embodied as a full circular-annular contour.

FIG. 3 shows a second exemplary embodiment, in which the same reference numerals are used further and will not be explained again. In this exemplary embodiment, the sealing element 26 is embodied as smooth, on its outer face toward the hammer barrel 10, and the restraining element 32 is embodied in the form of a barb 46. Because of the elastic deformability of the sealing element 26 and of the restraining element 32, which are embodied as a one-piece unit, it is easily possible to slide them into the hammer barrel 10. Once the sealing element 26 has reached its terminal position, it engages the free space of the counterpart element 38 with the restraining element 32 and is thus fixed.

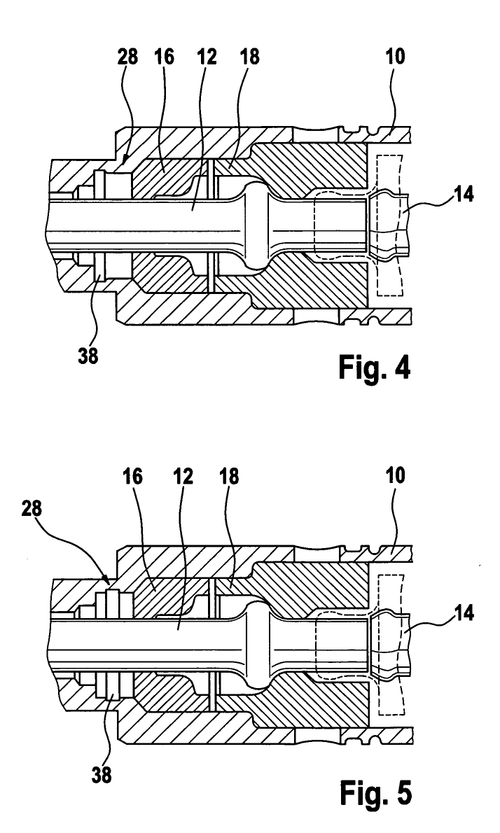

Finally, FIG. 4 and FIG. 5 show two advantageous possibilities for the location of the counterpart element 38. In FIG. 4, the counterpart element 38 is located at the front in the hammer barrel receptacle 28, that is, in the direction of the operating region A of the hand power tool 1, while in FIG. 5 the counterpart element 38 is located in the middle in the hammer barrel receptacle 28.

It will be understood that each of the elements described above, or two or more together, may also find a useful application in other types of constructions differing from the types described above.

While the invention has been illustrated and described as embodied in a hand power tool with percussion bolt sealing, it is not intended to be limited to the details shown, since various modifications and structural changes may be made without departing in any way from the spirit of the present invention.

Without further analysis, the foregoing will so fully revel the gist of reveal present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A hand power tool, comprising a percussion bolt; a hammer barrel receiving said percussion bolt; a sealing element effecting sealing between said percussion bolt and said hammer barrel; a restraining element that retains said sealing element at a predetermined point along said hammer barrel; and a counterpart element fixing said restraining element in a longitudinal direction of said hammer barrel, said restraining element being located on an outer face, toward said hammer barrel, of said sealing element.

2. A hand power tool as defined in claim 1, wherein said counterpart element has at least one partial circular-annular contour.

3. A hand power tool as defined in claim 2, wherein said counterpart element has a full circular-annular counter.

4. A hand power tool as defined in claim 1, wherein said counterpart element is composed of a plurality of counterpart element regions located in said longitudinal direction of said hammer barrel.

5. A hand power tool as defined in claim 1, wherein said counterpart element is configured as at least one indentation.

6. A hand power tool as defined in claim 5, wherein said at least one indentation is formed as a plunge cut.

7. A hand power tool as defined in claim 1, wherein said counterpart element has one flank which by bearing contact effects the fixing of said restraining element, and wherein a flank angle between said one flank of said counterpart element and a length of said hammer barrel is an obtuse angle.

8. A hand power tool as defined in claim 7, wherein said flank angle between said one flank of said counterpart element and said length of said hammer barrel is right angle.

9. A hand power tool as defined in claim 1, wherein said restraining element is integral with said sealing element.

10. A hand power tool as defined in claim 1, wherein said restraining element is configured as a bead pointing radially outward.

11. A hand power tool as defined in claim 1, wherein said retraining element is configured as a barb.

12. A hand power tool as defined in claim 1, wherein at least one element selected from the group consisting of a sealing element, a restraining element and both has an outer face provided toward said hammer barrel and being fluted.

13. A hand power tool as defined in claim 12, wherein a fluting of said outer face is adapted to a contour of said counterpart element.

14. A hand power tool as defined in claim 1, wherein said hammer barrel has a receptacle, said counterpart element being located at a front in said receptacle of said hammer barrel.

15. A hand power tool as defined in claim 1, wherein said hammer barrel has a receptacle, said counterpart element being located in a middle in said receptacle of said hammer barrel.
